(19) United States
(12) Patent Application Publication
(10) Pub. No.: US 2023/0011038 A1
(43) Pub. Date: Jan. 12, 2023

(54) Apparatus for restraining the lower legs and feet of a livestock animal

(71) Applicant: Jon Davis Mollhagen, Lorraine, KS (US)

(72) Inventor: Jon Davis Mollhagen, Lorraine, KS (US)

(21) Appl. No.: 17/863,207

(22) Filed: Jul. 12, 2022

Related U.S. Application Data
(60) Provisional application No. 63/220,853, filed on Jul. 12, 2021.

(51) Int. Cl. A01K 1/06

(52) U.S. Cl. CPC A01K 1/0613

(57) ABSTRACT

A livestock animal leg restraining apparatus includes a chute having a floor and sidewalls, a center pad assembly and two side pad assemblies. The center pad assembly is mounted in a raised position above the center of the floor of the chute. The center pad assembly presents two opposite center pads that are oriented in the outboard direction. Two side pad assemblies are mounted to pivot panels that are able to pivot out from the sidewalls of the chute from an open position to a closed position. Each side pad assembly presents a side pad that is oriented in an inboard direction. When the pivot panels are tilted to the closed position, the side pads are brought into close proximity with the center pads so as to restrain the lower legs of a livestock animal.

### CROSS REFERENCES TO RELATED APPLICATIONS

This application claims the benefit of U.S. Provisional Application No. 63/220,853 filed on Jul. 12, 2021, which is incorporated herein by reference in its entirety.

### FIELD

The present invention relates to an apparatus for restraining the lower legs of a livestock animal.

### BACKGROUND

Typical livestock animal chutes for restraining livestock animals have included inward moving panels within a frame which squeeze the body of the livestock animal. An apparatus which squeezes the body of the animal still leaves the legs free for kicking. A large livestock animal that is kicking presents a serious hazard to those who are working with the animal. The applicant has discovered that all that is needed to immobilize a large livestock animal is to immobilize all four feet of the animal. If all four feet are secured, the livestock animal is securely restrained and the livestock animal cannot kick. This capability would be particularly useful in a setting, such as a feed lot, in which cattle are moved through a squeeze chute in rapid succession, perhaps spending only approximately 30 seconds in the squeeze chute for, by way of example, a vaccination. Complete immobilization for a short interval is advantageous in such applications.

### SUMMARY

The present livestock animal leg restraining apparatus includes a chute having a floor and sidewalls, a center pad assembly and two side pad assemblies. The center pad assembly includes a center support member. The center pad assembly includes a center support member and padding that surrounds the sides and top of the center support member. The center support member, in this example, has a square or rectangular cross section. The center support member is supported above the floor of the chute preferably at the transverse center of the chute and preferably extends most of the length of chute. In this example, the padding includes three rubber tubes that are fixed to the opposite outboard sides and on the top side of the center support member. The three rubber tubes are wrapped in a sheet of rubber that is fixed to one side of the bottom surface of the center support member and which wraps around the three rubber tubes and is fixed to the opposite side of the bottom surface of the center support member. The rubber tubes and the sheet of rubber cooperate to present a top center pad on top of the center support member and opposite side center pads on each side of the center support member that are oriented in an outboard direction, thereby completing the center pad assembly. The center pads preferably extend at least most of the length of the center support member and most preferably the entire length of the center support member. Each side wall of the chute includes a pivoting side panel that is able to be actuated by an operator to pivot in unison about a longitudinal axis that is common to the chute sidewall and is, in this example, spaced above the floor of the chute for pivoting movement between an open position and a closed position. Each side pad assembly is mounted to one of the opposite pivoting side panels. Each side pad assembly includes a rigid side member that may have a square cross section. Three rubber tubes are fixed to the opposite top and bottom sides and to the inboard side of each side of each side member. A sheet of rubber is fixed to the upper portion of the outboard side of each side member and is wrapped around all three rubber tubes and is fixed to the bottom portion of the outboard side of each side member. The rubber tubes and the sheets of rubber cooperate to present opposite side pads that are oriented toward an inboard direction. The side pads preferably extend the length of the side members. The side pad assemblies and center pad assemblies are arranged so that when the pivoting side panels are pivoted in unison from the open position to the closed position, the side pads come into close proximity with the center pads. The elevation of the side pads and the center pads above the floor of the chute when they are in close proximity is arranged to coincide with each other and coincide with a portion of the lower legs of cattle that is above the hooves and ankles. Because the rubber tubes and the sheet material are resilient and flexible, the lower legs are squeezed in a relatively gentle manner with sufficient force to allow some movement but to prevent extraction of hooves and kicking.

### BRIEF DESCRIPTION OF THE DRAWINGS

FIG. 1 is a perspective view of a chute with one embodiment of a lower leg restraining apparatus.

FIG. 2 is a partial end view of a chute with the embodiment of the lower leg restraining apparatus shown in the open position.

FIG. 3 is a partial end view of a chute with the embodiment of a lower leg restraining apparatus shown in the closed position restraining the lower legs of a livestock animal.

FIG. 4 is a cut away end view of a center pad assembly of the embodiment of the lower leg restraining apparatus taken from plane A-A indicated in FIG. 1.

FIG. 5 is a cut away end view of a side pad assembly of the embodiment of the lower leg restraining apparatus taken from plane B-B indicated in FIG. 1.

FIG. 5A is a cut away end view of a second embodiment of a side pad assembly wherein the padding includes a side tube and an upper tube but does not include a bottom tube.

FIG. 6 is an end view taken from plane C-C indicated in FIG. 1 showing an actuator mechanism for moving a side panel between an open position and a closed position showing the side pad assembly for the leg restraining apparatus in the open position.

FIG. 7 is an end view taken from plane C-C indicated in FIG. 1 showing an actuator mechanism for moving a side panel between an open position and a closed position, but unlike as shown in FIGS. 1 and 2, and as shown in FIG. 3, showing the side pad assembly for the lower leg restraining apparatus in the closed position.

FIG. 8 is an end view from the same perspective as FIG. 7 with the same side panel position as shown in FIG. 7, showing an alternate embodiment actuator mechanism for moving a side panel between an open position and a closed position.

### DETAILED DESCRIPTION

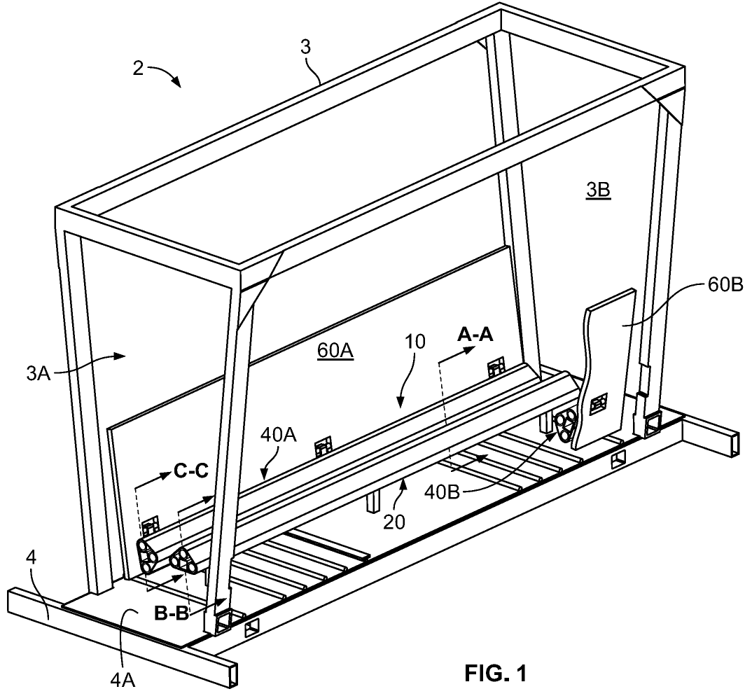

Referring to the drawings, FIG. 1 shows one embodiment of a leg restraining apparatus 10 which is incorporated into a livestock animal chute 2. Livestock animal chute 2 includes a frame 3 having a base 4. Base 4 presents a floor 4A which is suitable for being traversed by a livestock animal such as a cow, or a heifer or a steer. Frame 3 is arranged to define an entrance 3A and an exit 3B. Chute 2 may also support moving actuated side panels as part of a squeeze chute configuration for closing in on and restraining the upper body of the livestock animal. Such actuated side panels are shown and described in U.S. Pat. 6,425,351 but have been omitted in the figures for clarity.

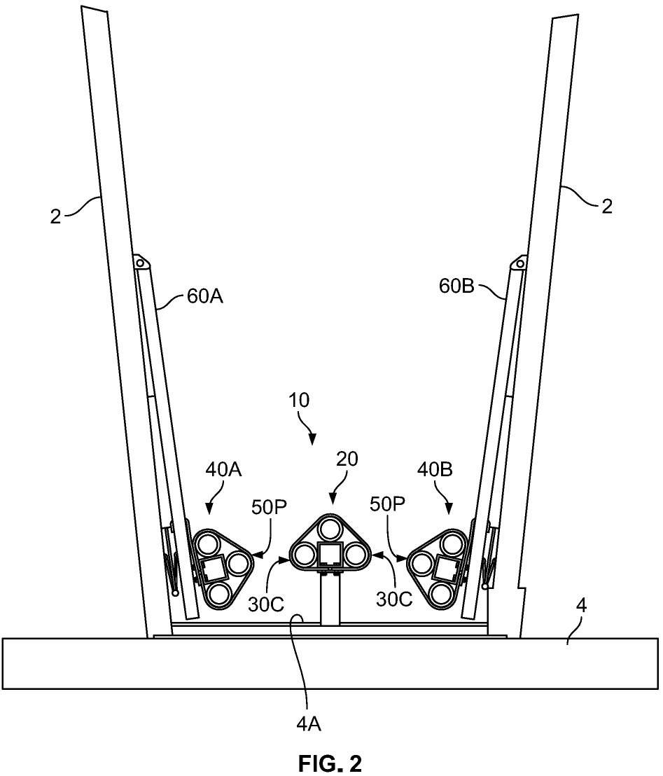

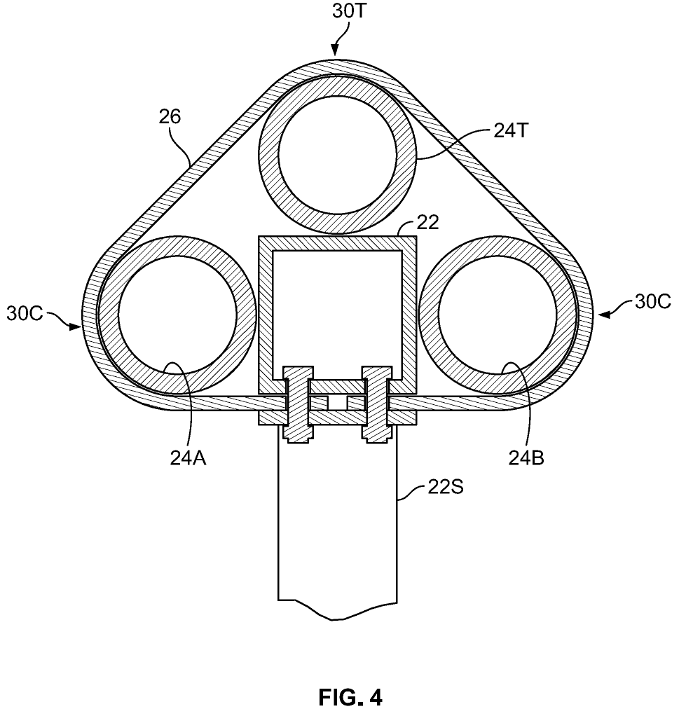

As can be seen in FIGS. 1-3, livestock animal leg restraining apparatus 10 includes a center pad assembly 20, a right side pad assembly 40A and a left side pad assembly 40B. As can be seen in FIGS. 2-4, center pad assembly 20 is mounted at the center of floor 4A and includes a center support member 22. Center support member 22 is supported above the floor by at least two spaced support columns 22S. It is preferable that center support member 22 be elevated at between six and eight inches above floor 104A and preferably immediately above the portion of the leg known as the “hock”. It is also preferable that center support member 22 extends most of the length of chute 02. Two rubber tubes including a left rubber tube 24A and a right rubber tube 24B are fixed on the opposite outboard sides of center support member 22. A top rubber tube 24T is fixed on top of center support member 22. A sheet of rubber 26 is fixed to one side of the bottom surface of center support member 22 and wraps around rubber tubes 24A, 24 T and 24B and is fixed to the opposite side of the bottom surface of the center support member 22. It is preferable that rubber tubes 24A, 24B and 24T be fashioned from rubber hose material. One possible option for the material for the rubber hoses described herein may be HOSECRAFT USA CM1 Single Ply Silicon Hose, part number, HOSE-CM1-1250-25 which is marketed by Hosecraft USA of Chicago, Illinois. An example material for rubber sheet 126 and other rubber sheets described herein might be the material that is used to make product number 33352980 for ¼″ thick black rubber sheet which may be obtained from mscdirect.com. The skilled reader should understand that comparable or identical tubes and rubber sheeting are also preferable for the side pad assemblies described below.

Rubber tubes 24A, 24B and 24T and rubber sheet 26 cooperate to present a top center pad 30T on top of center support member 22 and opposite side center pads 30C on each side of center support member 22. Side center pads 30C are oriented in an outboard direction. Top center pad 30T and side center pads 30C preferably extend the length of support member 22.

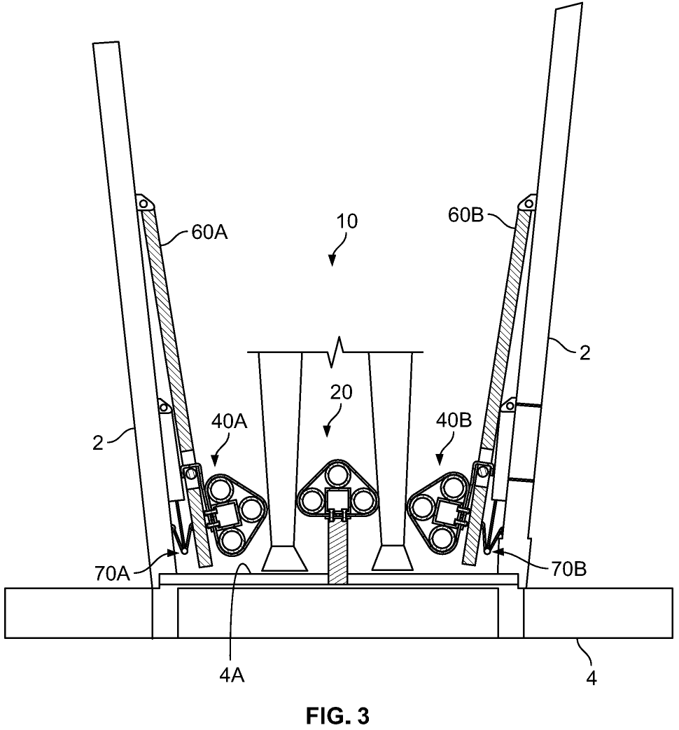

As can be seen in FIGS. 2, 3, 5 and 6, each side wall of chute 2 includes pivoting side panels 60A and 60B that is able to be actuated, preferably in unison, to pivot about a longitudinal axis that is spaced above the floor of the chute for pivoting movement between an open position as shown in FIG. 2 and a closed position as shown in FIG. 3. Each side pad assembly 40A and 40B is mounted to one of the pivoting side panels 60A and 60B respectively. For clarity, we will consider side pad assembly 40A while considering that side pad assembly 40B is a symmetrical, generally identical opposite of side pad assembly 40A.

Pivoting side panels 60A and 60B are shown in FIGS. 2, 3, 6, 7 and 8 as being pivotably mounted by pivot joints at the upper margins of side panels 60A and 60B to the sidewalls of livestock animal chute 2. The chute frame structure to which pivoting side panels 60A and 60B are pivotably mounted may alternatively include moving sidewalls that are capable of pivoting inwardly as are commonly used in squeeze chutes. U.S. Pat. 6,425,351 illustrates and describes such inwardly pivoting sidewalls, which are designated as sidewalls 9 and 11, and which are shown in FIG. 2 of that patent and described in column 4, lines 7 -26 of that patent. Thus, it is contemplated that pivoting side panels 60A and 60B, in some embodiments, may be pivotably mounted as shown in FIGS. 2, 3, 6, 7 and 8 and could be mounted to pivoting sidewalls of the type shown and described in U.S. Pat. 6,425,351. Thus, reference number 2 as indicated in FIGS. 2, 3, 6, 7 and 8 may be considered as indicating a portion of chute 2 that may also be a moving sidewall structure that is part of a livestock animal squeeze chute. The pivot axes for such moving sidewalls in a squeeze chute would be located very close to the lower ends of pivoting side panels 60A and 60B. Accordingly, any inward tilting movement of squeeze chute sidewalls would not cause any significant inward movement of side pad assemblies 40A and 40B. In FIGS. 2, 3, 6, 7 and 8, pivoting sidewalls that are mounted within livestock animal chute 2 for making squeeze chute functions possible have not been shown for simplicity of illustration and for clarity. However, the applicant contemplates that apparatus as described and claimed herein may be mounted to sidewalls that are pivoting sidewalls that are incorporated in a livestock animal squeeze chute.

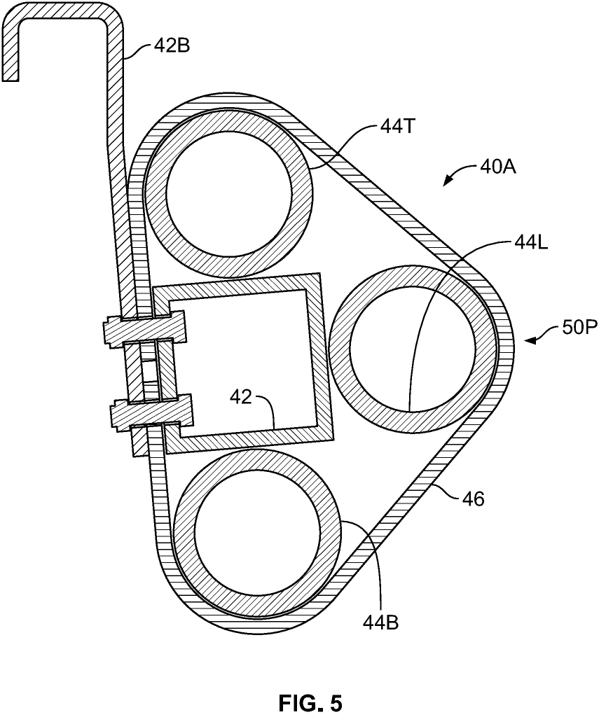

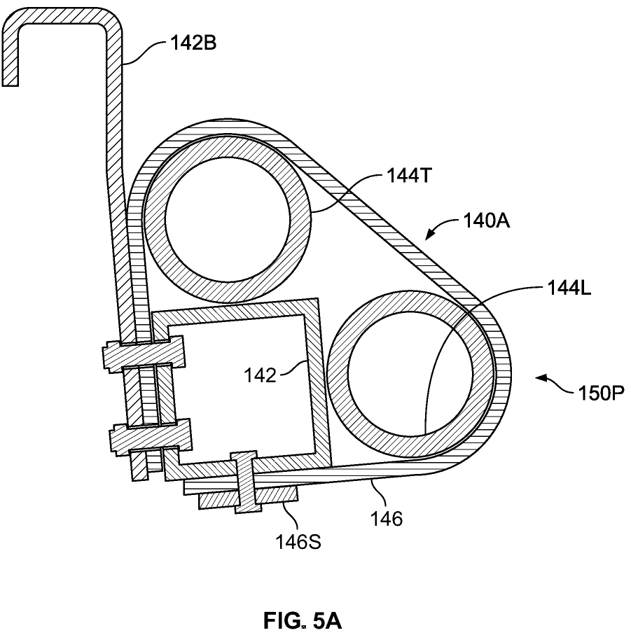

As is shown in FIG. 5, side pad assembly 40A includes a rigid side member 42 that, in this embodiment has a square cross section. A top rubber tube 44T is fixed to the top surface of side member 42 and a bottom rubber tube 44B is fixed to the opposite bottom side of side member 42. An inboard rubber tube 44L is fixed to the inboard surface of side member 42. A rubber sheet 46 is fixed to the upper portion of the outboard side of side member 42 and is wrapped around all three rubber tubes and is fixed to the bottom portion of the outboard side of side member 42. The means of fixing rubber sheet 46 to side member 42 as shown in FIG. 5 may be rivets as shown or other fasteners or possibly even various adhesives. Rubber tubes 44T, 44B and 44L and rubber sheet 46 cooperate to present a side pad 50P that is oriented in an inboard direction. Side pad 50P preferably extends the length of side member 42. As is shown in FIG. 5, and as can also be seen in FIG. 1, side pad assembly 40A also includes brackets 42B which are adapted to hook on to a corresponding feature that is presented by pivoting panel 60A. If the location and spacing of brackets 42B are symmetrical in a longitudinal direction as shown in FIG. 1, then opposite side panel assembly 42B may be fashioned to be identical to side panel assembly 42A.

FIG. 5A illustrates a second embodiment of a side pad assembly, namely side pad assembly 140A. The skilled reader should understand that an opposite and symmetrically identical side pad assembly (not shown) could be mounted to the opposite side panel in a symmetrical manner. In fact, if brackets 142B Side pad assembly 140A includes a rigid side member 142 that, in this embodiment also has a square cross section. A top rubber tube 144T is fixed to the top surface of side member 142. An inboard rubber tube 144L is fixed to the inboard surface of side member 142. However, no rubber tube is fixed to the lower surface of side member 142. A rubber sheet 146 is fixed to the outboard side of side member 142 and is wrapped around all rubber tube 144T and 144L and is fixed to bottom side of side member 142. The means of fixing rubber sheet 146 to side member 142 as shown in FIG. 5A may be rivets as shown or other fasteners or possibly even various adhesives. At the bottom side of member 142, it is advantageous to add a metal strip 146S (or a series of large washers) that would function to clamp rubber sheet 146 to side member 142 by clamping rubber sheet 146 between side member 142 and strip or series of washers 146S. Rubber tubes 144T and 144L and rubber sheet 146 cooperate to present a side pad 150P that is oriented in an inboard direction. Side pad 150P preferably extends the length of side member 142. As is shown in FIG. 5A, and as can further understood by the skilled reader by referring to FIG. 1, side pad assembly 140A also includes brackets 142B which are adapted to hook on to a corresponding feature that is presented by pivoting panel 60A. If the location and spacing of brackets 142B are symmetrical in a longitudinal direction as shown in FIG. 1, then opposite side pad assembly 142B may be fashioned to be identical to side panel assembly 142A.

Side pad assemblies 40A and 40B (or alternatively, side pad assemblies 140A and 140B) and center pad assembly 20 are arranged so that when pivoting side panels 60A and 60B are pivoted from the open position shown in FIG. 2 to the closed position shown in FIG. 3, side pads 50P come into close proximity with the corresponding center pads 30C. The elevation of side pads 50P and the center pads 30C above floor 40A of chute 2 when they are in close proximity is arranged to coincide with each other and coincide with a portion of the lower legs of cattle that is above the hooves and ankles as is shown in FIG. 3. Because the rubber tubes and the sheet material are resilient and flexible, the lower legs shown in FIG. 3 are squeezed in a relatively gentle manner with sufficient force to allow some movement but to prevent extraction of hooves and kicking.

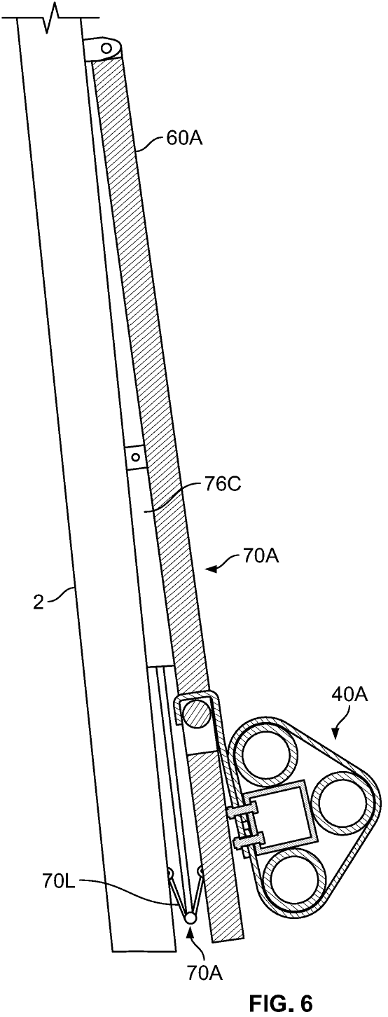

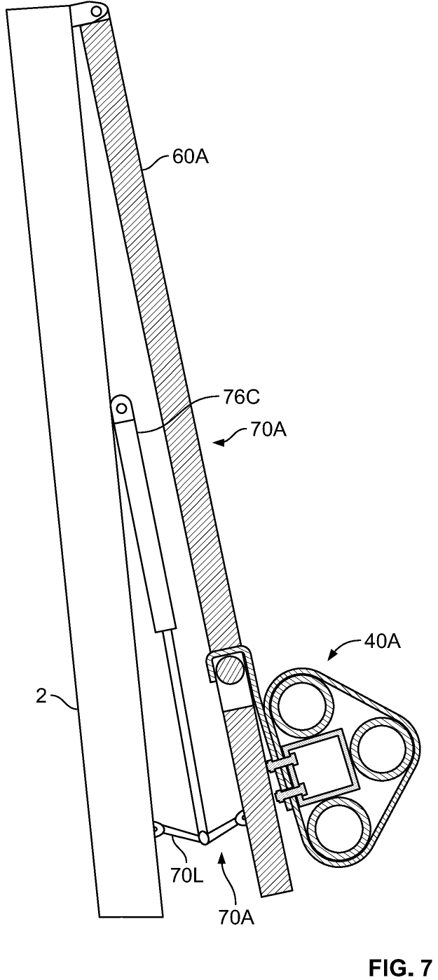

FIGS. 6 and 7 illustrate one embodiment of an actuator mechanism that may be employed for moving pivoting side panel 60A between the open position shown in FIGS. 2 and 6 and the closed position shown in FIGS. 3 and 7. As can be seen in this example, a two bar linkage extends between pivoting side panel 60A and a member of frame 3 of chute 2. An actuator 76C extends between the member of the frame of chute 2 to a point that is near or at the center of the two bar linkage. The first linkage in the two bar linkage is pivotably connected to the frame of chute 2 and to the distal end of the actuator rod of actuator 76C. The second linkage of the two bar linkage is pivotably connected to the distal end of the actuator rod of actuator 76C and pivotably connected to pivoting side panel 60A. Accordingly, when actuator 76C extends, pivoting panel 60A pivots to the open, outboard position shown in FIGS. 2 and 6 and when actuator 76C contracts, pivoting side panel 60A rotates to the closed, inboard position shown in FIGS. 3 and 7.

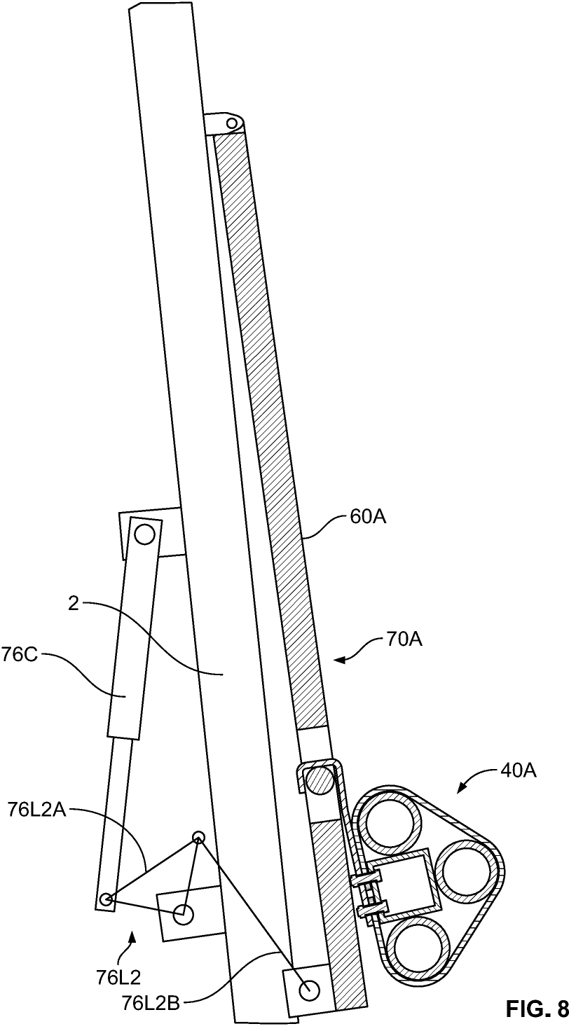

FIG. 8 illustrates a second embodiment of an actuator mechanism that may be employed for pivoting panel 60A between the open position shown in FIGS. 2 and 6 and the closed position shown in FIGS. 3 and 7. This second embodiment is shown in FIG. 8 merely to illustrate that any one of a number of actuator mechanisms may be employed for moving pivoting panel 60A. In FIG. 8, the distal end of the actuator rod of actuator 76C is pivotably connected to a rigid right angle element 76L2A which, in FIG. 8, is represented as a rigid triangle. The right angle element 76L2A is connected pivotably at its vertex to the frame of chute 2. A second member 76L2B is pivotably connected to the other end of rigid right angle element 76L2A and to pivoting side panel 60A. The skilled reader can readily appreciate how, as is the case with the first embodiment described above, when actuator 76C extends, pivoting side panel 60A pivots to the open, outboard, position shown in FIGS. 2 and 6 and when actuator 76C contracts, pivoting side panel 60A rotates to the closed, inboard, position shown in FIGS. 3 and 7.

As can be understood from the above description, leg restraining apparatus 10 is arranged so that when it is in the open position as shown in FIG. 2, the hooves of the livestock animal are directed between side pad assemblies 40A and 40B and center pad assembly 20 as the animal walks into chute 2. Once the animal is positioned with its lower legs between pad assemblies 40A and 40B and center pad assembly 20, leg restraining apparatus 10 may be moved to the closed position as shown in FIG. 3. In this embodiment, the combination of the rubber tubes and the rubber sheeting provide soft, resilient members for grasping the lower legs of the animal. The animal is restrained from kicking but it is not harmed. When leg restraining apparatus 10 is returned to the open position, the animal is free to move its hooves and lower legs and exit chute 2.

It is to be understood that while certain forms of this invention have been illustrated and described, it is not limited thereto, except in so far as such limitations are included in the following claims and allowable equivalents thereof.

1. A livestock animal leg restraining apparatus, comprising:
A livestock chute having a floor and sidewalls, a center pad assembly and two side pad assemblies, the center pad assembly being mounted in a raised position above the center of the floor of the chute, the center pad assembly presenting at least two opposite pads that are oriented in the outboard direction, the two side pad assemblies each being mounted to a pivoting side panel that is able to pivot out from a sidewall of the chute from an open position wherein each side pad assembly is in an outboard position to a closed position such that each side pad assembly is in an inboard position, each side pad assembly presenting a side pad that is oriented in an inboard direction, whereby, when the pivot panels are tilted in unison to the closed position, the side pads of the side pad assemblies are moved from the outboard position to the inboard position and into close proximity with the center pad assembly so as to restrain the lower legs of a livestock animal if the lower legs of a livestock animal are positioned between the center pad assembly and the side pad assemblies.

2. The livestock animal leg restraining apparatus of claim 1, wherein:
the center pad assembly includes a center support member and padding that surrounds the sides and top of the center support member.

3. The livestock animal leg restraining apparatus of claim 2, wherein:
the padding of the center pad assembly includes three rubber tubes that are fixed to the opposite outboard sides and to the top side of the center support member and the three rubber tubes are wrapped in a sheet of rubber that is fixed to one side of the bottom surface of the center support member and which wraps around the three rubber tubes and is fixed to the opposite side of the bottom surface of the center support member.

4. The livestock animal leg restraining apparatus of claim 1, wherein:
each side pad assembly includes a side support member and padding that surrounds at least the top and inboard side of each side support member.

5. The livestock animal leg restraining apparatus of claim 4, wherein:
the padding of each side pad assembly includes at least two rubber tubes that are fixed to at least the top and inboard sides of each side support member and the rubber tubes are wrapped in a sheet of rubber that is fixed to one side of the outboard surface of the side support member and which wraps around the rubber tubes and is also fixed to a side support member.

6. The livestock animal leg restraining apparatus of claim 1, wherein:
the center pad assembly includes a center support member and padding that surrounds the sides and top of the center support member, and the padding of the center pad assembly includes three rubber tubes that are fixed to the opposite outboard sides and to the top side of the center support member and the three rubber tubes are wrapped in a sheet of rubber that is fixed to one side of the bottom surface of the center support member and which wraps around the three rubber tubes and is fixed to the opposite side of the bottom surface of the center support member, and wherein, each side pad assembly includes a side support member and padding that surrounds the top, bottom and inboard side of each side support member, and, the padding of each side pad assembly includes at least two rubber tubes that are fixed to at least the top and inboard sides of each side support member and the rubber tubes are wrapped in a sheet of rubber that is fixed to one side of the outboard surface of the side support member and which wraps around the rubber tubes and is also fixed to a side support member.

7. The livestock animal leg restraining apparatus of claim 1, wherein:
each of the pivoting side panels has an axis of rotation that is spaced above the floor and adjacent to the sidewall of the livestock chute and each pivoting side panel is actuated by an actuator that is arranged for moving the lower margins of the pivot panels in unison between a first outboard position and a second inboard position.

8. The livestock animal leg restraining apparatus of claim 7, wherein:
the actuators are hydraulic actuators.
